(19) United States
(12) Patent Application Publication
(10) Pub. No.: US 2004/0114353 A1
(43) Pub. Date: Jun. 17, 2004

(54) Footwear having vessel containing light-scattering reflective devices

(76) Inventor: Thomas A. Romeo, Granite Bay, CA (US)

Correspondence Address: Dale C. Barr, Esq., DORSEY & WHITNEY LLP, Suite 3400, 1420 Fifth Avenue, Seattle, WA, 98101, US

(21) Appl. No.: 10/318,766

(22) Filed: Dec. 13, 2002

(51) Int. Cl. F21V 21/08

(52) U.S. Cl. 362/103; 362/806; 36/137; 359/518

(57) ABSTRACT

Footwear having a vessel containing light-scattering reflective devices are disclosed. In one embodiment, an assembly adapted to be worn on a user's foot includes a footwear device, and an at least partially transparent vessel attached to an outer surface of the footwear device. The vessel scalably contains a suspension medium. One or more reflective devices are disposed within the suspension medium. The footwear device may be a sneaker, a boot, a slipper, or any other suitable article of footwear. The reflective devices scatter light throughout the surrounding environment, attracting attention, increasing the user's enjoyment, and improving the visibility of the footwear device, especially in low light situations.

### TECHNICAL FIELD

The present invention relates to apparatus and methods for accessorizing footwear, and more particularly, to footwear having a vessel containing light-scattering reflective devices.

### BACKGROUND OF THE INVENTION

While the primary purpose of footwear has always been to support and protect a user's foot, footwear may also serve other purposes. For example, past efforts have been directed to improving the ornamental appearance of footwear to increase the wearer's enjoyment, as demonstrated by U.S. Pat. No. 6,477,754 issued to Alexander, U.S. Pat. No. 5,979,085 issued to Ross et al., and U.S. Pat. No. 5,845,422 issued to Valteau. Other efforts have been directed to equipping footwear with light-emitting devices to improve the aesthetic appearance of the footwear and to promote safety of the wearer, as demonstrated by U.S. Pat. No. 5,865,523 issued to Chien, and U.S. Pat. No. 5,758,946 issued to Chen. Although desirable results have been achieved using such prior art devices, there is still room for improving footwear to increase the wearer's enjoyment, improve aesthetic appearance, and promote safety of the wearer.

### SUMMARY OF THE INVENTION

The present invention is directed to apparatus and methods for footwear having a vessel containing light-scattering reflective devices. In one aspect, an assembly includes a footwear device, and an at least partially transparent vessel attached to an outer surface of the footwear device. The vessel sealably contains a suspension medium. One or more reflective devices are disposed within the suspension medium. In alternate aspects, the footwear device may be a sneaker, a boot, a slipper, or any other suitable article of footwear. The reflective devices scatter light throughout the surrounding environment, attracting attention, increasing the user's enjoyment, and improving the visibility of the footwear device, especially in low light situations.

### BRIEF DESCRIPTION OF THE DRAWINGS

FIG. 1 is an isometric view of a shoe having a heel-mounted vessel in accordance with an embodiment of the invention.

FIG. 2 is a rear elevational view of the shoe of FIG. 1.

FIG. 3 is an isometric view of the heel-mounted vessel of FIG. 1.

FIG. 4 is an isometric view of a shoe having side-mounted vessels in accordance with another embodiment of the invention.

FIG. 5 is a side elevational view of the rearward vessel of FIG. 4.

FIGS. 6A and 6B are side and top elevational views, respectively, of the forward vessel of FIG. 4.

FIGS. 7A and 7B are side and top elevational views, respectively, of a vessel in accordance with yet another embodiment of the invention.

FIGS. 8A and 8B are side and top elevational views, respectively, of a vessel in accordance with another alternate embodiment of the invention.

FIGS. 9A and 9B are side and top elevational views, respectively, of a vessel in accordance with a further embodiment of the invention.

FIGS. 10A and 10B are side and top elevational views, respectively, of a vessel in accordance with still another embodiment of the invention.

FIGS. 11A and 11B are side and top elevational views, respectively, of a vessel in accordance with another embodiment of the invention.

FIGS. 12A and 12B are side and top elevational views, respectively, of a vessel in accordance with yet another embodiment of the invention.

### DETAILED DESCRIPTION OF THE INVENTION

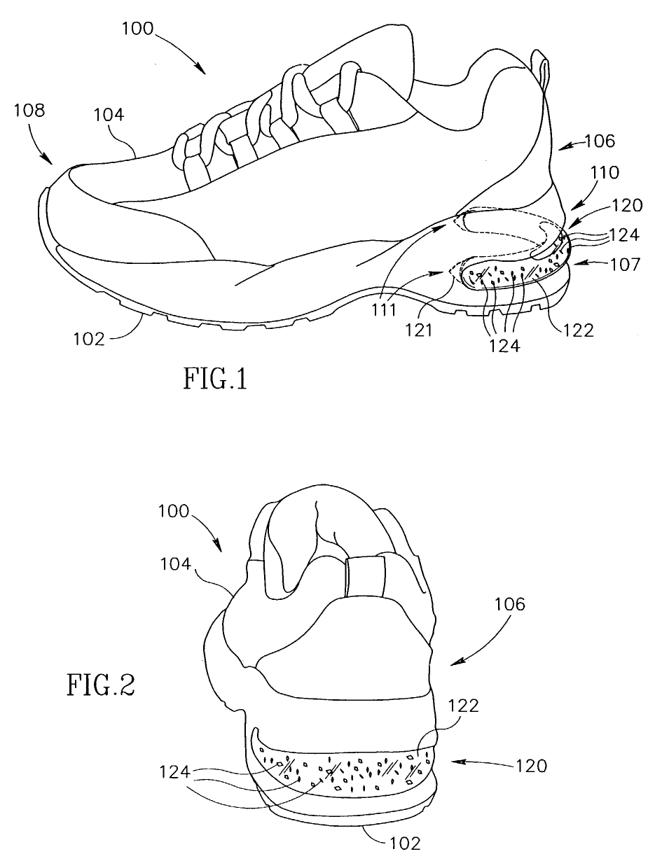

The present disclosure is generally directed toward novel apparatus and methods for footwear having a vessel containing light-scattering reflective devices. Many specific details of certain embodiments of the invention are set forth in the following description and in FIGS. 1-12 to provide a thorough understanding of such embodiments. One skilled in the art will understand, however, that the present invention may have additional embodiments, or that the present invention may be practiced without several of the details described in the following description.

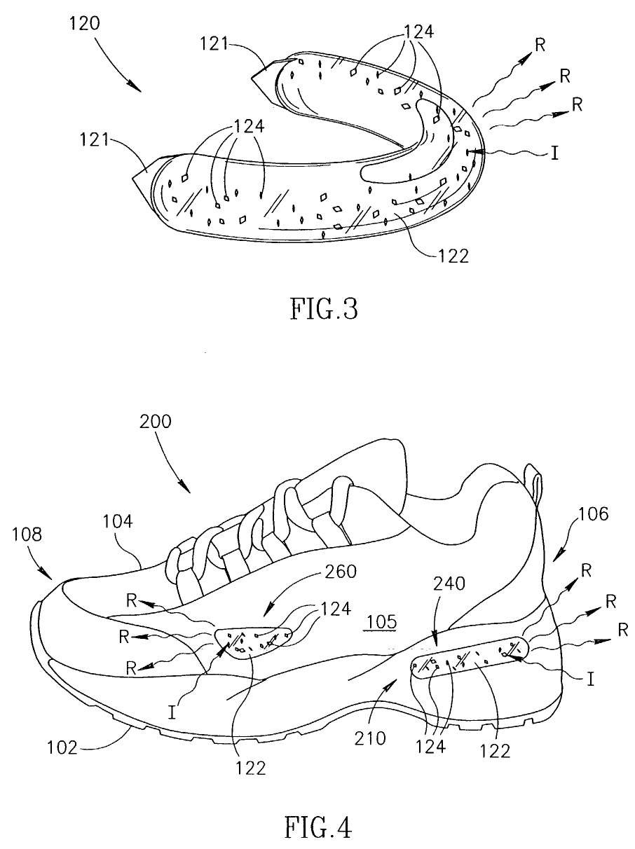

FIG. 1 is an isometric view of a shoe 100 having a heel-mounted vessel 120 in accordance with an embodiment of the invention. FIG. 2 is a rear elevational view of the shoe 100 of FIG. 1, and FIG. 3 is an isometric view of the heel-mounted vessel 120 of FIG. 1. As shown in FIGS. 1 and 2, the shoe 100 includes a sole 102 adapted to engage a bottom portion of a user's foot (not shown), and an upper portion 104 attached to the sole 102 and adapted to partially encapsulate and engage a top portion of the user's foot. The shoe 100 further includes a heel portion 106 proximate a heel of the user's foot, and a toe portion 108 proximate the toes of the user's foot. In this embodiment, a receptacle 110 is disposed within the heel portion 106 of the shoe 100, and the vessel 120 is partially disposed within the receptacle 110.

As best shown in FIG. 3, the vessel 120 includes a pair of mounting tabs 121 that projects outwardly from each end of the vessel 120. Each mounting tab 121 engages into a corresponding mounting slot 111 disposed within the shoe 100 at each end of the receptacle 110 (FIG. 1). The heel-mounted vessel 120 is constructed of a transparent (or partially transparent) material. The vessel 120 contains a suspension medium 122, and a plurality of reflective devices 124 are disposed within the suspension medium 122. In this embodiment, the suspension medium 122 is also transparent or partially transparent. A variety of materials may be used for the suspension medium 122, including water, oil, gel, or any other suitable material.

In operation, as the shoe 100 is worn by a user, the reflective devices 124 may move about randomly through the suspension medium 122 within the vessel 120. Because the vessel 120 and the suspension medium 122 are at least partially transparent, incident light I (FIG. 3) may pass through the vessel 120 and the suspension medium 122 and may impinge on the reflective devices 124. The reflective devices 124 may then scatter reflected light R (FIG. 3) randomly back out through the suspension medium 122 and the vessel 120 to the surrounding environment. In a particular embodiment, the reflective devices 124 may be a variety of different colors that provide a variety of different colors of reflected light R.

It should be understood that although the shoe 100 is depicted in FIGS. 1 and 2 as being a sneaker or tennis-type shoe, the inventive apparatus and methods should not be construed as being limited to this particular embodiment of footwear. In other words, the invention may be practiced using any type of footwear, including boots, sandals, slippers, loafers, swimming flippers, or any other suitable type of footwear. Thus, it should be understood that throughout the following discussion, the use of the term “shoe” is intended to encompass all different types and varieties of footwear.

The shoe 100 having the vessel 120 may provide several advantages over the prior art. For example, because the reflective devices 124 within the vessel 120 scatter reflected light R into the surrounding environment, the shoe 100 may be more attractive than prior art footwear. Also, the shoe 100 may receive more attention from bystanders, and may be more fun for the user to wear, especially for children. Thus, the shoe 100 may advantageously provide the user with increased wearing enjoyment. Also, because the shoe 100 having the vessel 120 with the light-scattering reflective devices 124 may be more enjoyable to wear, it may also promote increased footwear usage compared with prior art devices.

Furthermore, the shoe 100 may provide improved safety for the user, especially in low-light situations. Because the reflective devices 124 reflect and scatter incident light I into the surrounding environment, the shoe 100 having the vessel 120 may be more highly visible than prior art footwear. Thus, because the shoe 100 may be more visible, the user of the shoe 100 may also be more visible, thereby reducing the risk of accidents, particularly in low-light situations such as jogging or walking home from school in the evening of after sunset.

Several alternate embodiments of footwear apparatus in accordance with the invention will be described below. Generally, in the following discussion, where the construction and operation of alternate embodiments is substantially similar to the embodiment described above, the common elements and features are identified by reference numbers which are the same or similar to those used above. For the sake of brevity, only significant differences in construction or operation are described in detail.

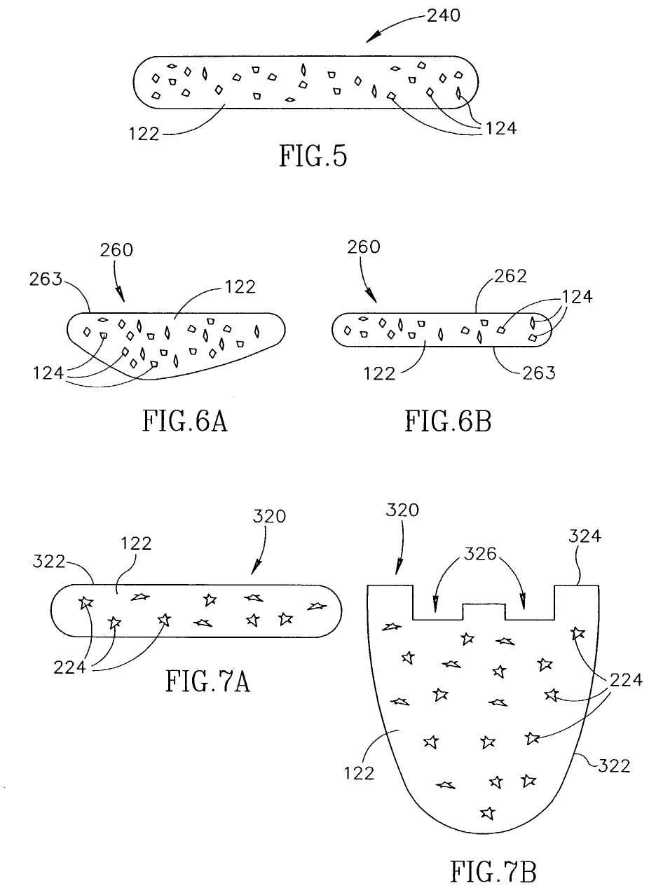

FIG. 4 is an isometric view of a shoe 200 having side-mounted vessels 240, 260 in accordance with another embodiment of the invention. Specifically, the shoe 200 includes a rearward vessel 240 and a forward vessel 260. FIG. 5 is a side elevational view of the rearward vessel 240 of FIG. 4, and FIGS. 6A and 6B are side and top elevational views, respectively, of the forward vessel 260 of FIG. 4.

In the embodiment shown in FIG. 5, the rearward vessel 240 is an approximately cylindrical shape having rounded ends. Again, the rearward vessel 240 is a transparent (or partially transparent) vessel 220 that sealably contains a suspension medium 122 having a plurality of reflective devices 124 disposed therein. Referring again to FIG. 4, the shoe 200 includes a side receptacle 210, and the rearward vessel 240 is partially disposed within the side receptacle 210 similar to the heel-mounted vessel 120 described above (FIGS. 1 and 2).

As shown in FIGS. 6A and 6B, the forward vessel 260 is a relatively flat vessel having an inner, attachment surface 262 and an outer surface 263. As shown in FIG. 4, the attachment surface 262 of the forward vessel 260 is attached directly to an exterior surface 105 on the upper portion 104 of the shoe 200. In this embodiment, there is no mounting receptacle for the forward vessel 260. The attachment surface 262 may be either transparent, partially transparent, or opaque, while the outer surface 263 is wholly or partially transparent.

In operation, as the shoe 200 moves during use, the reflective devices 124 move randomly through the suspension medium 122 in the side-mounted forward and rearward vessels 240, 260, scattering reflected light R (FIG. 4) into the surrounding environment. Thus, the shoe 200 having the side-mounted forward and rearward vessels 240, 260 may provide that above-noted advantages of improving the attractiveness of the footwear, increasing attention from bystanders, and making the footwear more fun for the user to wear. The shoe 200 may also promote increased usage of footwear, and may provide improved safety for the user, especially in low-light situations.

One may note that the above-described vessels may have a wide variety of shapes, sizes, configurations, and mounting positions, and that the inventive apparatus and methods are not limited to the particular vessel embodiments and mounting locations described above. By way of illustration, the heel-mounted vessel 120 may be varied from the particular embodiment shown in FIGS. 1-3 to a wide variety of suitable vessel embodiments, including but not limited to those embodiments depicted in FIGS. 7A through 10B. Specifically, FIGS. 7A and 7B are side and top elevational views, respectively, of an alternate embodiment of a vessel 320. In this embodiment, the vessel 320 includes an approximately U-shaped outer perimeter 322 and an inner end 324 having a pair of anchoring cutouts 326 disposed therein (FIG. 7B). The vessel 320 may be inserted, for example, into a receptacle 110 disposed in a mid-sole portion 107 (FIG. 1) of the shoe 100 between the sole 102 and the heel portion 106 so that the outer perimeter 322 is at least partially visible to bystanders.

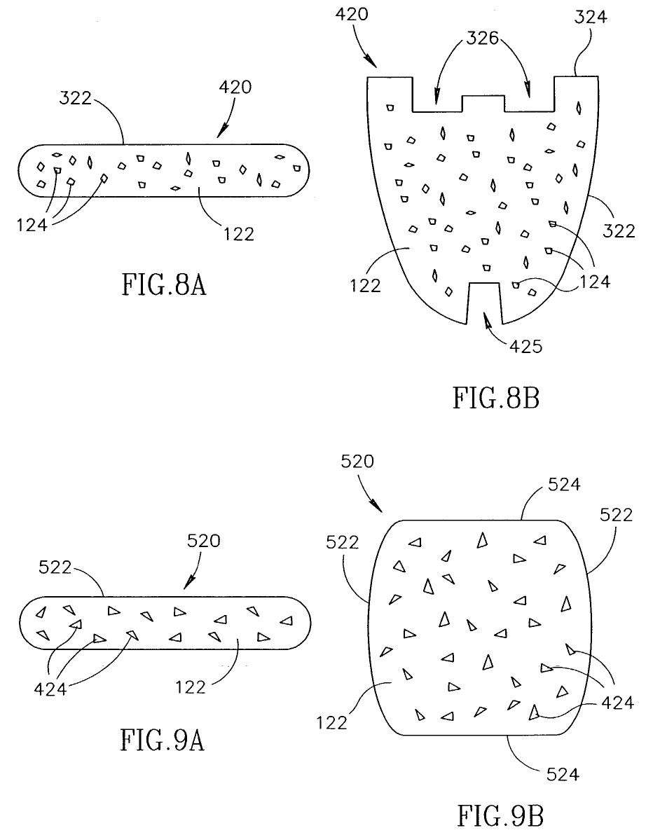

Similarly, FIGS. 8A and 8B are side and top elevational views, respectively, of another embodiment of a vessel 420 in accordance with the invention. The vessel 420 is very similar to the previously described embodiment, however, in this embodiment, the vessel 420 includes a heel notch (or gap) 425 within the outer perimeter 322 (FIG. 8B). Again, the vessel 420 may be inserted into a receptacle 110 disposed in the mid-sole portion 107 or heel portion 106 (FIG. 1) with the outer perimeter 322 at least partially visible to bystanders.

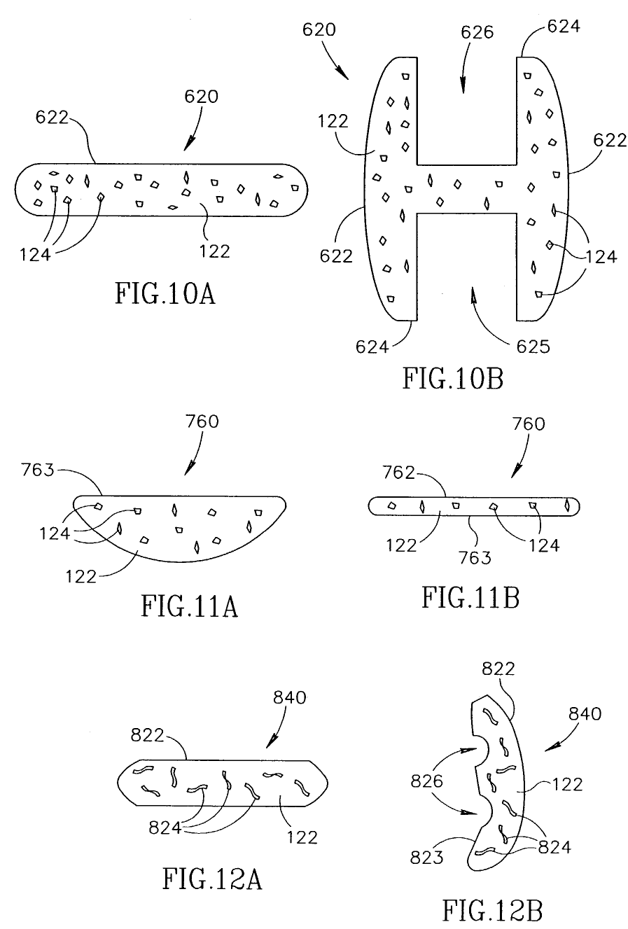

Furthermore, FIGS. 9A and 9B are side and top elevational views, respectively, of yet another embodiment of a vessel 520 having a pair of curved lateral edges 522 and a pair of flat ends 524 (FIG. 9B). The vessel 520 may be inserted into a receptacle 110 disposed in the shoe 100 with the curved lateral edges 522 at least partially visible from the outside of the shoe 100. Also, FIGS. 10A and 10B are side and top elevational views, respectively, of a vessel 620 in accordance with still another embodiment of the invention. In this embodiment, the vessel 620 has curved lateral edges 622 and ends 624 having a large heel notch 625 and a large anchor notch 626. Again, the vessel 620 may be mounted, affixed, or inserted into the shoe 100 so that the curved lateral edges 622 are at least partially visible.

Similarly, the side-mounted vessel embodiments are not limited to the particular rearward and forward vessels 240, 260 shown in FIG. 4. For example, FIGS. 11A and 11B are side and top elevational views, respectively, of another embodiment of a vessel 760 in accordance with the invention. In this embodiment, the vessel 760 is a relatively flat configuration having an attachment surface 762 (FIG. 11B) that attaches to an exterior surface 105 of the shoe 200, and an outer surface 763 that faces away from the shoe 200 through which light may pass to impinge upon the reflective devices 124. Similarly, FIGS. 12A and 12B are side and top elevational views, respectively, of a vessel 840 in accordance with yet another embodiment of the invention. The vessel 840 includes a curved, outer edge 822, and an inner edge 823 having a pair of anchor cutouts 826. In operation, the vessel 840 is attached to an outer surface of the shoe 200 with the inner edge 823 edged with the shoe 200 and the transparent (or partially transparent) outer edge 822 facing outwardly.

As noted above, the above-described vessels may be positioned at any desired location on the footwear device, and the inventive apparatus and methods are not limited to the particular vessel mounting locations described above. Thus, in accordance with the present invention, any suitable vessel embodiment may be attached, embedded, affixed or otherwise coupled to the footwear device at any desired exterior location. In particular, any of the vessel embodiments described above and shown in the accompanying figures may be positioned at any desired location on the footwear device.

Finally, it should be noted that the reflective devices 124 may assume a wide variety of shapes, sizes, colors, densities, and configurations. For example, in one embodiment, the reflective devices 124 may be small squares of reflective metallic material, commonly referred to as “glitter” (FIGS. 1-6B). Alternately, the reflective devices may include star-shaped reflective devices 224 (FIGS. 7A and 7B), or small reflective strips 824 (FIGS. 12A and 12B), or any other desired shape or configuration, including combinations of the above-described embodiments.

The detailed descriptions of the above embodiments are not exhaustive descriptions of all embodiments contemplated by the inventors to be within the scope of the invention. Indeed, persons skilled in the art will recognize that certain elements of the above-described embodiments may variously be combined or eliminated to create further embodiments, and such further embodiments fall within the scope and teachings of the invention. It will also be apparent to those of ordinary skill in the art that the above-described embodiments may be combined in whole or in part to create additional embodiments within the scope and teachings of the invention.

Thus, although specific embodiments of, and examples for, the invention are described herein for illustrative purposes, various equivalent modifications are possible within the scope of the invention, as those skilled in the relevant art will recognize. The teachings provided herein can be applied to other apparatus and methods for footwear having a vessel containing light-scattering reflective devices, and not just to the embodiments described above and shown in the accompanying figures. Accordingly, the scope of the invention should be determined from the following claims.

1. An assembly adapted to be worn on a user's foot, comprising:
a footwear device; and
an at least partially transparent vessel attached to an outer surface of the footwear device and sealably containing a suspension medium, one or more reflective devices being disposed within the suspension medium.

2. The assembly according to claim 1 wherein the footwear device comprises a sneaker.

3. The assembly according to claim 1 wherein the one or more reflective devices comprise one or more squares of reflective metallic material.

4. The assembly according to claim 3 wherein the at least partially transparent vessel comprises an at least partially transparent exterior surface and an opaque attachment surface attached to the outer surface of the footwear device.

5. The assembly according to claim 1 wherein the at least partially transparent vessel comprises a relatively flat vessel.

6. The assembly according to claim 1 wherein the at least partially transparent vessel comprises an approximately cylindrical vessel.

7. The assembly according to claim 1 wherein the footwear device includes a heel portion adapted to be positioned proximate a heel of the user's foot, and wherein the at least partially transparent vessel is attached to the outer surface of the footwear device proximate the heel portion.

8. The assembly according to claim 1 wherein the footwear device includes a side portion, and wherein the at least partially transparent vessel is attached to the outer surface of the footwear device proximate the side portion.

9. The assembly according to claim 1 wherein the outer surface of the footwear device includes a receptacle, and wherein the at least partially transparent vessel is at least partially disposed in the receptacle.

10. The assembly according to claim 1 wherein the outer surface of the footwear device includes a receptacle having at least one mounting slot disposed therein, and wherein the at least partially transparent vessel includes at least one mounting tab projecting therefrom, the at least partially transparent vessel being at least partially disposed in the receptacle with the mounting tab projecting into the mounting slot.

11. A method of accessorizing a footwear device, comprising:
providing a footwear device; and
coupling to the footwear device an at least partially transparent vessel sealably containing a suspension medium, one or more reflective devices being disposed within the suspension medium.

12. The method according to claim 11 wherein providing a footwear device comprises providing a sneaker.

13. The method according to claim 11 wherein coupling to the footwear device an at least partially transparent vessel comprises coupling to the footwear device an at least partially transparent vessel including one or more squares of reflective metallic material disposed within the suspension medium.

14. The method according to claim 11 wherein coupling to the footwear device an at least partially transparent vessel comprises coupling to the footwear device an at least partially transparent vessel including one or more reflective strips disposed within the suspension medium.

15. The method according to claim 11 wherein coupling to the footwear device an at least partially transparent vessel comprises at least partially disposing an at least partially transparent vessel within a mounting receptacle on an exterior surface of the footwear device.
